(19) United States
(12) Patent Application Publication
(10) Pub. No.: US 2005/0197731 A1
(43) Pub. Date: Sep. 8, 2005

(54) Data structure for cloth animation, and apparatus and method for rendering three-dimensional graphics data using the data structure

(75) Inventors: Jeonghwan Ahn, Seoul (KR); Dokyoon Kim, Gyeonggi-do (KR); Sangoak Woo, Gyeonggi-do (KR); Nikolay Yurievich Gerasimov, Saint-Petersburg (RU); Sergey Urievich Belyaev, (US)

Correspondence Address: STAAS & HALSEY LLP, SUITE 700, 1201 NEW YORK AVENUE, N.W., WASHINGTON, DC, 20005, US

(73) Assignee: Samsung Electroncics Co., Ltd., Suwon-si (KR)

(21) Appl. No.: 11/064,970

(22) Filed: Feb. 25, 2005

(30) Foreign Application Priority Data
Feb. 26, 2004 (KR) 10-2004-0012985
Mar. 8, 2004 (KR) 10-2004-0015607

(51) Int. Cl. D05B 21/00; G06F 19/00

(52) U.S. Cl. 700/130

(57) ABSTRACT

A data structure for cloth animation and an apparatus and method of rendering 3D graphics data using the data structure. The data structure for cloth animation comprises a vertical granulation field, a horizontal granulation field, a height field, a width field, and a physical characteristics node which defines values for physical characteristics, a shift position of the cloth due to forces acting on the cloth, and due to a collision of the cloth with an object. The 3D graphics data rendering apparatus comprises an analyzer for outputting a scene graph, a calculator for calculating physical quantities for the cloth animation, and a converter for converting the scene graph comprising the calculated physical quantities into a 2D image and outputting the 2D image.

### CROSS-REFERENCE TO RELATED APPLICATIONS

This application claims the priority of Korean Patent Application No. 2004-12985, filed on Feb. 26, 2004, and No. 2004-15607, filed on Mar. 8, 2004, in the Korean Intellectual Property Office, the disclosures of which are incorporated herein in their entirety by reference.

### BACKGROUND OF THE INVENTION

1. Field of the Invention

The present invention relates to rendering of three-dimensional graphics data, and more particularly, to a data structure for graphical cloth animation which allows a graphical cloth to be realistically animated in real time, and an apparatus and method of rendering three-dimensional graphics data using the data structure.

2. Description of the Related Art

In order to read data from files which store data regarding a three-dimensional (3D) graphical image (hereinafter 3D graphics data) and to output the data to a screen, an apparatus is required which analyzes the 3D graphics data and records the 3D graphics data on a video memory for storing data to be output to the screen. In general, the apparatus is called a 3D graphics rendering engine.

In general, the 3D graphics data comprises information on the geometry of an object located in a three-dimensional space, a material of the object, a position and characteristics of a light source, and variation of such information with time. Examples of the information on the geometry of the object comprise locations of 3D fixed points forming the object, links of the fixed points, etc. Examples of the information on the material of the object comprise colors, the light reflectance of a surface, etc. Such information is represented in an intuitively or logically understandable structure so that users can create and modify the 3D graphics data easily. The structure is typically referred to as a scene graph, which has an acyclic tree structure. The scene graph is composed of nodes comprising information on the geometry or material of the object, and information on links of the nodes. In other words, the node is one of the elementary components of the scene graph. Fields define specific characteristics of the node.

Recently, as rendering processors for 3D graphics data have improved in performance, the desire for a more realistic representation of natural objects has increased. Conventional 3D graphics techniques have animated 3D models in a simple manner. In recent years, it has become easy to create adequate virtual environments and to express the imagination of a developer by representing natural phenomena, such as running water, wind, and smoke, and the motion of a person's hair or clothes.

In representing the motion of cloth, both intrinsic characteristics of the cloth and external physical factors such as gravity, wind, acceleration, and air resistance must be considered. In addition, effects of contact with external objects on the cloth should be considered.

Recently, a number of methods of taking these physical factors into consideration in animation have been proposed. However, since the proposed methods are performed in their own formats, it is impossible to render and animate general purpose 3D graphics models. In addition, it is difficult for users to write adequate programs due to the complicated physical characteristics of objects. In addition, rendering tools and authoring tools are incompatible because they use different formats. In addition, there has been a problem in that created models cannot be reused.

### SUMMARY OF THE INVENTION

Accordingly, it is an aspect of the present invention to provide a data structure for animating a graphical cloth which defines nodes and fields for a realistic and real-time animation in commercial programs such as virtual reality modeling language (VRML), moving picture experts group (MPEG), 3D MAX, MAYA, etc.

It is also an aspect of the present invention to provide an apparatus and method of rendering 3D graphics data which renders a 3D cloth model into a 2D image by using the data structure for cloth animation.

Additional aspects and/or advantages of the invention will be set forth in part in the description which follows and, in part, will be obvious from the description, or may be learned by practice of the invention.

The foregoing and/or other aspects are achieved by providing a data structure for animation of a cloth comprising: a vertical granulation field which defines granulation along the vertical axis of a planar mesh of the cloth; a horizontal granulation field which defines granulation along the horizontal axis of the planar mesh of the cloth; a height field which defines a height of the planar mesh of the cloth; a width field which defines a width of the planar mesh of the cloth; and a physical characteristics node which defines values for physical characteristics used to calculate external and internal forces acting on the cloth, a shift position of the cloth due to the forces, and a shift position of the cloth due to a collision of the cloth with an object.

The physical characteristics node, in order to calculate the external forces acting on the cloth, may comprise a gravitational acceleration field which defines a gravitational acceleration used to calculate a gravitational force; a wind velocity field which defines a wind velocity used to calculate an air resistance; a buffer coefficient field which defines a buffer coefficient used to calculate an external buffering force; and an air resistance coefficient field which defines a resistance coefficient used to calculate the air resistance. In addition, the physical characteristics node, in order to calculate the internal forces acting on the cloth, may comprise a maximum elongation field which defines a maximum elongation of a spring linking mass-points on a lattice composing the planar mesh of the cloth; a planar force resistance coefficient field which defines a resistance coefficient of a spring linking each mass-point in the lattice with first neighboring mass-points directly on the right, the left, above, and below; a shift deformation resistance coefficient field which defines a resistance coefficient of a spring linking each mass-point with neighboring mass-points in a diagonal direction; and a torsion resistance coefficient field which defines a resistance coefficient of a spring linking each mass-point with every second mass-point on the right, the left, above, and below the first neighboring mass-points being therebetween. In addition, the physical characteristics node may comprise an inverse mass field which defines an inverse mass of each of mass-points in a lattice used for obtaining acceleration used to calculate the shift position of the cloth due to the forces acting on the cloth. In addition, the physical characteristics node may comprise a time interval field which defines a time interval used to calculate the shift position of the cloth.

The data structure may further comprise a fixed edge field which defines an edge of the mesh of the cloth that is fixed. In addition, the data structure may further comprise a collision node used to calculate the shift position of the cloth due to collision of the cloth with an object and to represent the object. The collision node may comprise a friction coefficient field used to calculate a shift velocity of a point at which the object collides with the cloth; a kinematics node which defines a virtual object colliding with the cloth; and a visible shape node used to actually represent the object colliding with the cloth.

The foregoing and/or other aspects are also achieved by providing a 3D graphics data rendering apparatus comprising: an analyzer to output a scene graph obtained by discriminating nodes and analyzing fields from 3D graphics data having a data structure for the cloth animation; a calculator to calculate physical quantities for animation of a cloth from the nodes and the fields of the scene graph and to output the scene graph comprising the calculated physical quantities; and a converter to convert the scene graph comprising the calculated physical quantities into a 2D image and to output the 2D image. The calculator may comprise a cloth discriminating unit to discriminate the nodes of the scene graph; a cloth mesh creating unit to create a mesh of the cloth according to the nodes and the fields; a colliding object discriminating unit to discriminate whether the object is colliding with the cloth; a collision detection unit to determine whether the cloth collides with the object; a physical quantity calculating unit to calculate physical quantities which represent the internal and external forces acting on the cloth and shift position of the cloth due to the collision with the object; and a cloth mesh deforming unit to deform the structure of the cloth by applying the shift position of the cloth calculated by the physical quantity calculating unit to the mesh of cloth, and to output the scene graph comprising the physical quantities. The collision detection unit detects whether the cloth collides with the object defined by a kinematics node. In addition, the collision detection unit detects a location of a collision point when the cloth collides with the object defined by a kinematics node.

According to another aspect of the present invention, there is provided a 3D graphics data rendering method comprising: outputting a scene graph obtained by discriminating nodes and analyzing fields from 3D graphics data having a data structure for the cloth animation; calculating physical quantities for animation of a cloth from the nodes and fields of the scene graph and outputting the scene graph comprising the calculated physical quantities; and converting the scene graph comprising the calculated physical quantities into a 2D image and outputting the 2D image.

### BRIEF DESCRIPTION OF THE DRAWINGS

The above and/or other aspects and advantages of the present invention will become more apparent by describing in detail exemplary embodiments thereof with reference to the attached drawings in which:

FIG. 1 is a diagram showing a geometric structure of a cloth used in conjunction with the present embodiment of the invention;

FIG. 2 is a diagram showing the cloth of FIG. 1 represented in a triangular mesh in an “x-z” coordinate system;

FIG. 3 is a chart showing an example of node and field values used in a ClothAnim node according to the embodiment of the present invention;

FIG. 4 is a chart showing an example of field values used in a ClothAnimPhy node according to the embodiment of the present invention;

FIG. 5A is a chart showing an example of node and field values used in a colliders node according to the embodiment of the present invention,

FIG. 5B is a chart showing an example of field values used in a TruncatedCone node according to the embodiment of the present invention, and

FIG. 5C is a chart showing an example of a field value used in a kinematics node according to the embodiment of the present invention;

FIG. 6 is a block diagram showing the structure of an apparatus for rendering 3D graphics data according to the embodiment of the present invention;

FIG. 7 is a block diagram of an analyzer shown in FIG. 6;

FIG. 8 is a block diagram of a calculator shown in FIG. 6;

FIG. 9 is a block diagram of a converter shown in FIG. 6;

FIG. 10 is a flowchart showing a 3D graphics data analyzing process in a rendering method according to the embodiment of the present invention;

FIG. 11 is a flowchart showing a calculating process in a rendering method according to the embodiment of the present invention;

FIG. 12 is a flowchart showing a process of converting a scene graph comprising calculated physical quantities into a 2D image in a rendering method according to the embodiment of the present invention;

FIG. 13 is a diagram showing an example of rendering using nodes and fields defined according to the embodiment of the present invention;

FIG. 14 is a diagram showing an example of rendering using a conventional interpolator node;

FIG. 15 is a diagram showing an example of animated collision of a spherical object with the cloth by a rendering method according to the embodiment of the present invention;

FIG. 16 illustrates a colliders node used for implementing the animation of FIG. 15; and

FIG. 17 illustrates a ClothAnim node used for implementing the animation FIG. 15.

### DETAILED DESCRIPTION OF THE PREFERRED EMBODIMENTS

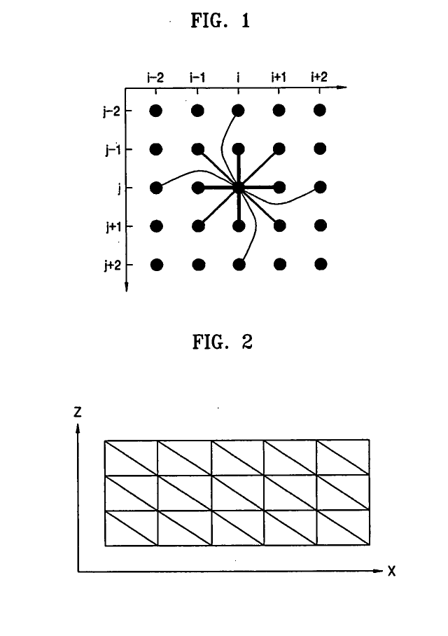

Reference will now be made in detail to the embodiment of the present invention, an example of which is illustrated in the accompanying drawings, wherein like reference numerals refer to the like elements throughout. The embodiment is described below to explain the present invention by referring to the figures. First, a physical model of cloth is set forth. FIG. 1 shows a geometric structure of cloth. Modeling of the cloth takes advantage of a rectangular lattice composed of mass-points, as disclosed in “Deformation Constraints In a Mass-Spring Model to Describe Rigid Cloth Behavior,” by X. Provot, Graphics Interface '95, pp. 147-158. Each mass-point is linked to neighboring mass-points by three different types of springs.

First, springs which link a mass-point (i, j) to mass-points (i+1, j), (i−1, j), (i, j+1), and (i, j−1), which are the thickest solid lines in FIG. 1, exhibit a frame of the cloth. The springs resist tension within a plane surface of the cloth. Second, springs which link the mass-point (i, j) to mass-points (i+1, j+1), (i−1, j+1), (i+1, j−1), and (i−1, j−1), which are the middle-thickness solid lines in FIG. 1, resist shift deformation within a plane surface of the cloth. Third, springs which link the mass-point (i, j) to mass-points (i+2, j), (i−2, j), (i, j+2), and (i, j−2), which are the thinnest solid lines in FIG. 1, resist torsion from the outside of a plane surface of the cloth. Next, forces acting on each mass-point in the lattice are set forth. Motion of each mass-point is governed by Newton's second law of motion as shown in Equation 1.
mᵢⱼ\ddot{x}ᵢⱼ=Fᵢⱼ [Equation 1]
where m ᵢⱼ denotes the mass of a mass-point (i, j) in a lattice, xy denotes a spatial position vector of the mass-point, and Fᵢⱼ denotes the net force vector acting on the mass-point.

Internal and external forces act on each mass-point. The internal forces are produced by the elastic links between neighboring mass-points. The external forces comprise gravity, air resistance, buffering force, etc.

The internal forces are now set forth. Let T(i, j) be a set of mass-points (k, l). The mass-points (k, l) are linked to the mass-points (i, j) by springs. In this case, the internal forces, Fᵢⱼ^{int}, acting on the mass-points (i, j) can be calculated as follows:

$${F}_{ij}^{int} = {\sum }_{( k , l ) ∈ T ( i , j )} {K}_{ijkl} ( 1 - \frac{{L}_{ijkl}}{\vert {r}_{kl} - {r}_{ij} \vert} ) ( {r}_{kl} - {r}_{ij} ) \qquad [ Equation 2 ]$$

where Kᵢⱼₖₗ denotes the stiffness (spring constant) of a spring linking the mass-point (i, j) with the mass-point (k, l), Lᵢⱼₖₗ denotes the length of the spring in an equilibrium state, rᵢⱼ denotes a position vector of the mass-point (i, j), and rₖₗ denotes a position vector of the mass-point (k, l).

Next, the external forces can be largely classified into gravity, buffering force, air resistance, and relative acceleration.

The force of gravity, Fᵢⱼ^{g}, is defined by Equation 3.
Fᵢⱼ^{g}=mᵢⱼg [Equation 3]
where mᵢⱼ is mass of a mass-point (i, j), and g is the vector acceleration due to gravity.

The external buffering force, Fᵢⱼ^{d}, is defined by Equation 4.
Fᵢⱼ^{d}=−μvᵢⱼ [Equation 4]
where μ is a buffer coefficient, and vᵢⱼ=rᵢⱼ is a velocity vector of the mass-point (i, j).

The force of air resistance, Fᵢⱼ^{a}, is defined by Equation 5.
Fᵢⱼ^{a}=c(nᵢⱼ−(u_{w}−vᵢⱼ))nᵢⱼ [Equation 5]
where c is a resistance coefficient, nᵢⱼ is a normal vector of the mass-point (i, j), and u_{w} is a wind velocity vector.

The force due to relative acceleration, Fᵢⱼ^{r}, is defined by Equation 6.
Fᵢⱼ^{r}=−mᵢⱼ(a₀+ε×rᵢⱼ+ω×(ω×rᵢⱼ)+2ω×vᵢⱼ) [Equation 6]
where a₀ is a linear acceleration vector, and ω and ε are angular velocity and angular acceleration vectors, respectively, in a coordinate system in which the motion of a portion of the cloth is considered.

The net force, Fᵢⱼ(t), is obtained by summing up the internal and external forces as follows:
Fᵢⱼ(t)=Fᵢⱼ^{int}+Fᵢⱼ^{g}+Fᵢⱼ^{d}+Fᵢⱼ^{a}+Fᵢⱼ^{r} [Equation 7]

In order to calculate the shift positions of the mass-points, Euler's method, an elementary numerical analysis method, is used. The spatial location vector, rᵢⱼ, and the velocity vector, vᵢⱼ, for all mass-points are assumed to be known at time t. The location and velocity vectors for all mass-points at time t+τ are calculated as follows:
rᵢⱼ(t+τ)=rᵢⱼ(t)+vᵢⱼ(t)τ [Equation 8]
vᵢⱼ(t+τ)=vᵢⱼ(t)+aᵢⱼ(t)τ [Equation 9]
where rᵢⱼ and vᵢⱼ are the first and second terms in the Taylor's series expansion when rᵢⱼ and vᵢⱼ are assumed to be differentiable at time t. Thus, the approximate position at time t+τ can be obtained. In addition, the approximate velocity at time t+τ can be obtained from Equation 9. The acceleration vector of the mass-point required for Equation 9 is obtained as follows:

$${a}_{ij} ( t ) = \frac{1}{m} {F}_{ij} ( t ) \qquad [ Equation 10 ]$$

Next, a collision of the cloth with another object is set forth. It is assumed that the cloth collides with a rigid body having a predetermined shape, such as sphere, cone, cylinder, or rectangle.

At this time, two operations should be performed. A first operation is to detect whether a certain mass-point of the cloth is located in the colliding object, in order to determine whether a collision in fact occurs. A second operation is to detect a colliding location on a surface of the colliding object on which a certain mass-point of the cloth is projected, in order to calculate the shift position of the cloth due to the collision.

According to such a method, the shift position of the mass-point of the cloth can be calculated without detecting a penetration moment.

When the position vector of the mass-point of the cloth, yᵢⱼ, is located on the colliding object, the velocity vector, vᵢⱼ, is calculated as follows:

$${v}_{ij} = \{ \begin{matrix}{v}_{t} ( 1 - {k}_{f} \frac{\vert {v}_{n} \vert}{\vert {v}_{t} \vert} ) , \vert {v}_{t} \vert \geq {k}_{f} \vert {v}_{n} \vert \\ 0 , \vert {v}_{t} \vert < {k}_{f} \vert {v}_{n} \vert\end{matrix} \qquad [ Equation 11 ]$$

where vₜ and vₙ are a tangential velocity component vector and a normal velocity component vector of the mass-point at a position of the mass-point, yᵢⱼ, respectively, and k_{f} is a friction coefficient at a penetration point. In order to obtain necessary values, such as velocity, a normal line to the surface of the object, and a friction coefficient, it is assumed that the position of the mass-point, yᵢⱼ, is projected onto the surface of the object and a penetration phenomenon occurs at the projected location.

When positions of all mass-points of the cloth at time steps are obtained according to Euler's method, the position vector of the mass-point of the cloth, yᵢⱼ, can be obtained at time t+τ as follows:
yᵢⱼ(t+τ)=xᵢⱼ(t)+τvᵢⱼ(t) [Equation 12]

Meanwhile, a data structure for the cloth animation can be defined by several nodes as described below. These nodes comprise the ClothAnim, clothAnimPhys, and colliders nodes.

As described above in conjunction with FIG. 1, the cloth is modeled by using a rectangular lattice composed of the mass-points, and each of the mass-points moves due to internal and external forces. In addition, each of the mass-points moves due to collision with a spherical or rectangular rigid body. FIG. 2 shows the cloth represented in a triangular mesh in an “x-z” coordinate system.

The ClothAnim node is composed of field values for the mass-points which represent the cloth having the mesh structure of FIG. 2, and nodes and field values related to the internal forces, the external forces, and the collision acting on the mass-points.

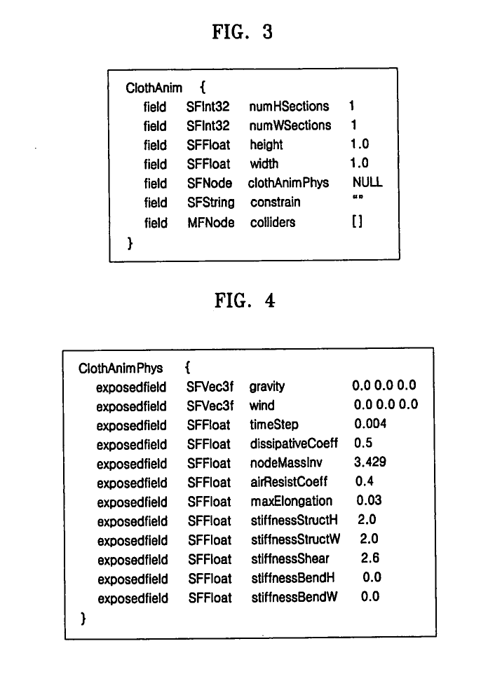

An example of the nodes and field values used for the ClothAnim node is shown in FIG. 3. Fields for the ClothAnim node comprise a numHSections field, a numWSections field, height and width fields, a clothAnimPhys node, a constrain field, and a colliders node. The numHSections field defines granulation of a planar mesh along the “z” axis, and the numWSections field defines granulation of the planar mesh along the “x” axis. In FIG. 2, the numHSections is 3 and the number of numWSections is 5. The height field defines the height of the planar mesh along the “z” axis. The width field defines the width of the planar mesh along the “x” axis.

The planar mesh of the cloth in FIG. 2 is composed of the numHSections, numWSections, height and width fields. The height field value divided by the numHSections field value, and the width field value divided by the numWSections field value are Lᵢⱼₖₗ of an initial state in Equation 2 for obtaining the internal force.

The clothAnimPhys node defines physical characteristics of the cloth. Several ClothAnim nodes may share the clothAnimPhys node. If the clothAnimPhys node is NULL as shown in FIG. 3, the value for the node is not defined and a predetermined value is used. The fields of the clothAnimPhys node are set forth later.

The constrain field has any one of “left”, “right”, “top”, and “bottom” strings. The constrain field defines a fixed edge in the mesh of the rectangular cloth. When the field is set to “left”, the left edge does not move but all other edges can move in the mesh of the cloth. The constrain field can be used in animation in which a flag fixed to a flagpole flutters in the wind. However, if the string is not defined in the constrain field as shown in FIG. 3, all edges can move.

The colliders node has a “Kinematics” node to be considered in collision detection, which is described later.

The motion of the cloth is determined by internal forces between the mass-points and the external forces such as gravity, air resistance, and buffering force. The clothAnimPhys node has values for these forces.

An example of field values used in the clothAnimPhys node is shown in FIG. 4. The clothAnimPhys node is composed of a gravity field, a wind field, a timeStep field, a dissipativeCoeff field, a nodeMasslnv field, an airResistCoeff field, a maxElongation field, a stiffnessStructH field, a stiffnessStructW field, a stiffnessShear field, a stiffnessBendH field, and a stiffnessBendW field.

Among these fields, the gravity field defines a gravitational acceleration vector, g, and is used for calculating gravity. The wind field defines a wind velocity vector, U_{w}, and is used for calculating air resistance. The timeStep field defines a time interval, τ, used for calculating the location and velocity of the mass-point according to Euler's method. The dissipativeCoeff field defines a buffer coefficient, μ, which is used for calculating the external buffering force. The nodeMassInv field defines the inverse mass of the mass-point, m⁻¹, and is used for calculating the acceleration due to the internal and external forces. Assuming that the density of the cloth is uniform, the mass of each of the mass-points can be regarded to be the same. The airResistCoeff field defines a resistance coefficient, c, which is used for calculating the air resistance. The maxElongation field defines a maximum elongation of a spring which links the mass-points. If the spring is over elongated, it retracts forcibly. The stiffnessStructH field defines the stiffness of the spring along the “z” axis. The spring resists tension within the plane surface of the cloth. The stiffnessStructW field defines stiffness of the spring along the “x” axis. The spring resists tension within the plane surface of the cloth. The stiffnessShear field defines the stiffness of the spring which links mass-points in a diagonal direction. The value corresponds to the shift deformation (shear) within the plane surface of the cloth. The stiffnessBendH field defines the stiffness of the spring which links every other neighboring mass-point in the direction of the “z” axis. The spring resists torsion from the outside of the plane of the cloth. The stiffnessBendW field defines the stiffness of the spring which links every other neighboring mass-point in the direction of the “x” axis. The spring resists torsion from the outside of the plane surface of the cloth. The stiffnessStructH field, stiffnessStructW field, stiffnessShear field, stiffnessBendH field, and stiffnessBendW field are Kᵢⱼₖₗ used for calculating the internal force.

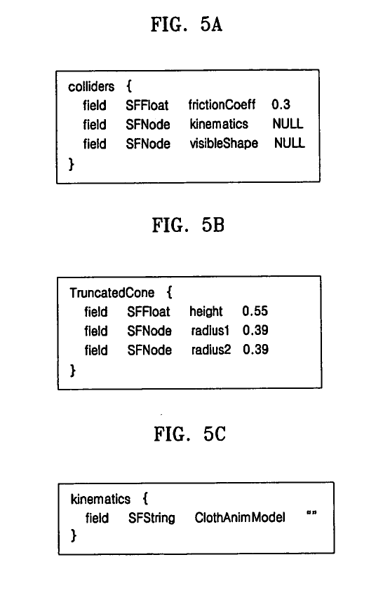

The colliders node defines a collision of the ClothAnim node. An example of the colliders node and field values is shown in FIG. 5A. The colliders node is composed of a frictionCoeff field, a kinematics node, and a visibleShape node. The frictionCoeff field defines a friction coefficient, k_{f}, which is used in a collision response process.

The kinematics node defines a virtual object colliding with the ClothAnim node. There are two methods of defining the kinematics node.

First, the DEF name of the kinematics node can be defined in a field of the colliders node in the ClothAnim node. In this field, the kinematics node can have two geometry nodes which are already defined in the VRML standard. These are the Box and Sphere nodes. The Kinematics node also has a geometry node which is not defined in the VRML standard. This is a TruncatedCone node. In the case of the “Sphere” node, the radius of the sphere should be defined and the sphere has the same shape as the Sphere node used in the VRML standard. In the case of the “Box” node, the size of the box should be defined and the box has the same shape as the Box node used in the VRML standard. In case of the “TruncatedCone” node, the height and the radii of the upper and lower surfaces of the curve should be defined. If the radii of the upper and lower surfaces are the same, the node has the shape of a cylinder. If the radius of either the upper surface or the lower surface is 0, the node has the shape of a cone. An example of the TruncatedCone node is shown in FIG. 5B.

Second, the kinematics node can have a value for the clothAnimModel field which defines a virtual object which collides with the ClothAnim node. An example of the kinematics node is shown in FIG. 5C. The clothAnimModel can have three primitive shapes, “Sphere”, “Box”, and “TruncatedCone”, which are the same as those of the geometry node.

The visibleShape node is used for showing the object which collides with a real cloth on a screen and has the Shape node defined in the VRML standard.

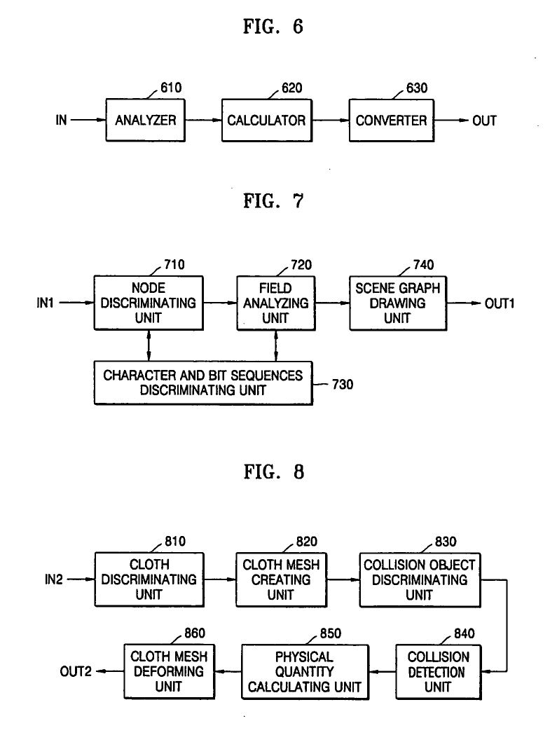

Next, a rendering apparatus and method according to the embodiment of the present invention will be described in detail with reference to FIGS. 6 to 13.

FIG. 6 is a block diagram of a rendering apparatus according to the embodiment of the present invention. The rendering apparatus comprise an analyzer 610, a calculator 620, and a converter 630.

The analyzer 610 outputs a scene graph which is obtained by discriminating nodes and analyzing fields from the 3D graphics data IN having the data structure for the cloth animation. The calculator 620 calculates physical quantities for the cloth animation from the nodes and fields of the scene graph and outputs the scene graph comprising the calculated physical quantities. The converter 630 converts the scene graph comprising the calculated physical quantities into a 2D image OUT and outputs the converted image.

FIG. 7 is a block diagram of the analyzer 610 of FIG. 6. The analyzer 610 comrpises a node discriminating unit 710, a field analyzing unit 720, a character and bit sequences discriminating unit 730, and a scene graph drawing unit 740. The function of each unit of the analyzer 610 will now be described with reference to FIG. 10, which is a flowchart showing a process of analyzing the data IN.

The node discriminating unit 710 discriminates nodes from the 3D graphics data IN (operation S1000). The character and bit sequences discriminating unit 730 analyzes character sequences of the node input from the node discriminating unit 710 and outputs the analyzed character sequences of the node to the node discriminating unit 710. According to the discriminated nodes, the node discriminating unit 710 can discriminate whether the 3D graphics data is information on the geometry of an object, the material of an object, etc. Next, a space to be filled with fields is created in the node analyzed in the node discriminating unit 710 (operation S1010). The character and bit sequences discriminating unit 730 analyzes characters or binary bit sequences of the fields input from the field analyzing unit 720 and outputs the analyzed sequences to the field analyzing unit 720. The field analyzing unit 720 analyzes the 3D graphics data to fill the space with the field values (operation S1020). The scene graph drawing unit 740 outputs the scene graph OUT1 constituted by inserting nodes having the analyzed field values (operation S1030). The scene graph has nodes comprising information on the geometry of mass-points composing the cloth, such as positions and links of the mass-points, material of the cloth, and so on. Next, in the analyzing process, it is determined whether the 3D graphics data has more nodes to be analyzed (operation S1040). If the 3D graphics data has more nodes to be analyzed, the analyzing process returns to operation S1000 and is repeated. If not, the analyzing process ends.

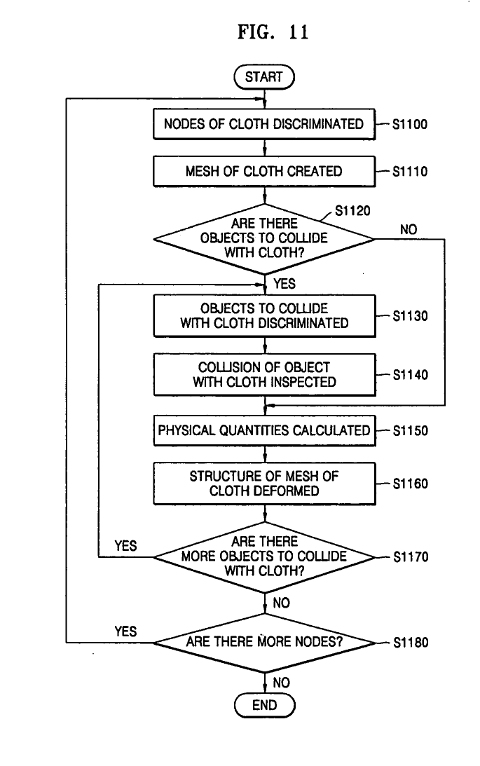

FIG. 8 is a block diagram showing the calculator 620 of FIG. 6. The calculator 620 comprises a cloth discriminating unit 810, a cloth mesh creating unit 820, a colliding object discriminating unit 830, a collision detection unit 840, a physical quantity calculating unit 850, and a cloth mesh deforming unit 860. The function of each unit of the calculator 620 will now be described with reference to FIG. 11, which is a flowchart showing a process of calculating the scene graph performed in the calculator 620.

The cloth discriminating unit 810 discriminates the nodes of the cloth in an input scene graph IN (operation S1100). The cloth mesh creating unit 820 creates a mesh of the cloth according to the nodes and fields analyzed in the analyzer 610 (operation S1110). Next, the colliding object discriminating unit 830 determines whether there is an object colliding with the cloth in the input scene graph IN2, that is, whether there is a colliders node (operation S1120).

If there is no object colliding with the cloth, the calculating process proceeds to operation S1150. If there is an object colliding with the cloth in operation S1120, the geometry of the colliding object is discriminated from the information on the geometry of the colliders node (operation S1130). The collision detection unit 840 detects whether the object collides with the cloth (operation S1140). More particulary, the collision detection unit 840 detects whether a virtual object defined by the kinematics node collides with the cloth. If the virtual object collides with the cloth, the collision detection unit 840 detects the position of the collision point.

Next, if there is an object colliding with the cloth, the physical quantity calculating unit 850 calculates the physical quantities such as the internal and external forces, the shift position of the cloth due to these forces, the shift position of the cloth due to the collision, etc. If not, the physical quantity calculating unit 850 calculates the physical quantities such as the internal and external forces, the shift position of the cloth due to these forces, etc. (operation S1150). The calculated forces and shift position are the same as described above. The cloth mesh deforming unit 860 deforms the structure of the mesh of the cloth on the basis of the calculated physical quantities, and outputs the scene graph comprising the calculated physical quantities (operation S1160). Next, the calculating process determines whether there are more objects to collide with the cloth (operation S1170). If there are more objects to collide with the cloth, the calculating process returns to operation S1130. If not, the calculating process determines whether there are more nodes to calculate (operation S1180). If there are more nodes to calculate, the calculating process returns to operation S1100. If not, the calculating process of the scene graph ends.

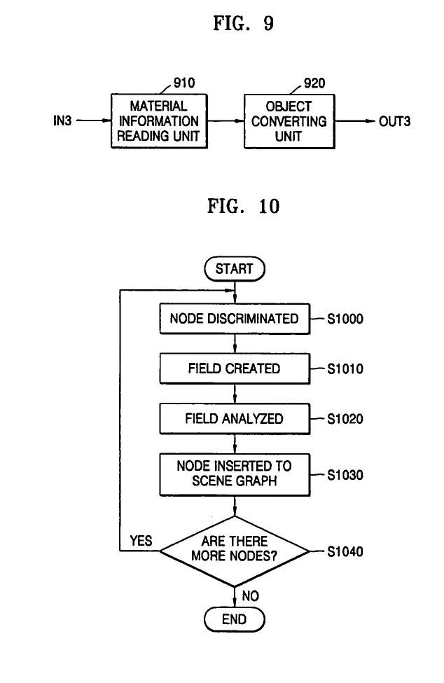

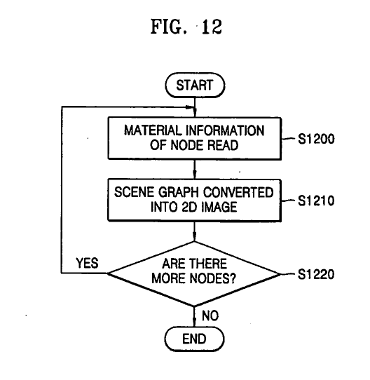

FIG. 9 is a block diagram showing the converter 630 of FIG. 6. The converter 630 comprises a material information reading unit 910 and an object converting unit 920. The function of each unit of the converter 630 will now be described with reference to FIG. 12, which is a flowchart showing a converting process of the scene graph into a 2D image.

The material information reading unit 910 reads information on the material of the node from the scene graph IN3 input from the calculator 620 (operation S1200). For instance, the information on the material of the node comprises texture, transparency, etc. The object converting unit 920 converts the scene graph having the information on the physical quantities calculated by using the information on the material into a 2D image OUT3 through an appropriate conversion of coordinates, and outputs the converted image (operation S1210). Next, the material information reading unit 910 determines whether there are more nodes to convert (operation S1220). If there are more nodes to convert, the converting process returns to operation S1200 and is repeated. If not, the converting process ends.

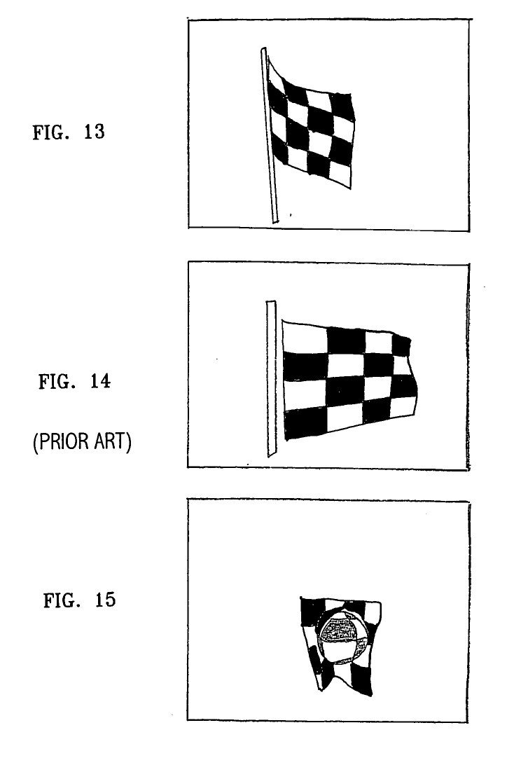

FIG. 13 shows an example of rendering using the nodes and fields defined according to the embodiment of the present invention. FIG. 14 shows an example of rendering using a conventional interpolator node. The file for FIG. 13 is 1,568 bytes in size, and the file for FIG. 14 is 1,375,061 bytes in size. Therefore, the rendering method according to the embodiment of the present invention uses a file that is approximately 876 times smaller in size than the file used in the conventional method of using the interpolator node.

FIG. 15 shows an example of an animated collision of a spherical object with the cloth created by the rendering method according to the embodiment of the present invention. A naturally crumpled shape can be seen when the spherical object collides with the cloth.

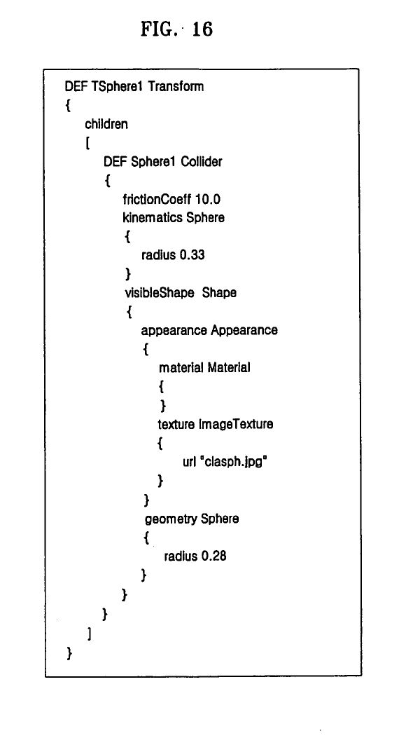

FIG. 16 shows a colliders node used for implementing the animation of FIG. 15. The colliders node has a frictionCoeff field in order to define a friction coefficient used during a collision response process. In addition, the kinematics node may have a geometry node called Sphere, and defines the object colliding with the cloth. The visibleShape node has an appearance node called Appearance and a geometry node called Sphere. Here, the appearance node has information on the appearance. The material node has information on colors of the colliding object. When a path of an image is written to a url field of the texture node, the image is applied.

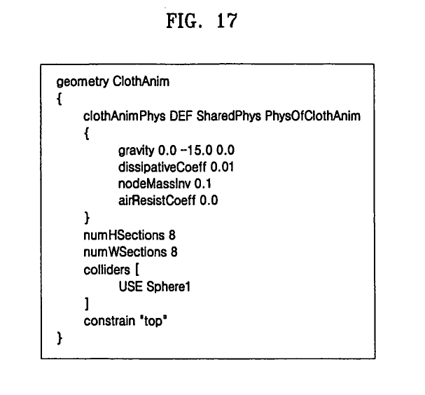

FIG. 17 shows a ClothAnim node which uses the colliders node of FIG. 16 for implementing the animation of FIG. 15. The ClothAnim node performs the animation of the cloth by calling the colliders node.

The embodiment of the present invention can be implemented as computer-readable codes stored on computer-readable recording media. The computer comprises all apparatuses having the function of information processing. The computer-readable recording media comprises all kinds of recording apparatuses for storing data which can be read by a computer system. Examples of the computer-readable recording apparatuses comprise ROM, RAM, CD-ROM, magnetic tape, floppy disks, optical data storage apparatuses, etc.

According to the embodiment of the present invention, the nodes can create 3D graphics from the lattice-shaped cloth and describe the internal characteristics of the cloth. In addition, it is possible to realistically represent motion by considering forces acting on the cloth, such as gravity, air resistance, the force of the wind, etc., and forces associated with a collision with an external rigid body. In addition, it is possible for anyone to produce a desired animation easily by simply changing node and field values, since the entire animation is possible by changing only several field values on the node. In addition, the volume of data is small as compared to a conventional interpolator animation, since it is possible to produce a desired animation by changing field values only. In particular, the VRML and MPEG-4 standards, which are regarded as standards in 3D graphics, fail to support the animation of cloth. However, the present invention can represent the node according to these standards. While the present invention has been described with reference to exemplary embodiments thereof, it will be understood by those skilled in the art that various changes in form and details may be made therein without departing from the scope of the present invention as defined by the following claims.

1. A data structure for animation of a cloth, comprising:
a vertical granulation field which defines a granulation along a vertical axis of a planar mesh of the cloth;
a horizontal granulation field which defines a granulation along a horizontal axis of the planar mesh of the cloth;
a height field which defines a height of the planar mesh of the cloth;
a width field which defines a width of the planar mesh of the cloth; and
a physical characteristics node which defines values of physical characteristics used to calculate external and internal forces acting on the cloth, a shift position of the cloth due to the forces, and a shift position of the cloth due to a collision of the cloth with an object.

2. The data structure for animation of a cloth according to claim 1, wherein the physical characteristics node, in order to calculate the external forces acting on the cloth, comprises:
a gravitational acceleration field which defines a gravitational acceleration used to calculate a gravitational force;
a wind velocity field which defines a wind velocity used to calculate an air resistance;
a buffer coefficient field which defines a buffer coefficient used to calculate an external buffering force; and
an air resistance coefficient field which defines a resistance coefficient used to calculate the air resistance.

3. The data structure for animation of a cloth according to claim 1, wherein the physical characteristics node, in order to calculate the internal forces acting on the cloth, comprises:
a maximum elongation field which defines a maximum elongation of a spring linking mass-points in a lattice corresponding to the planar mesh of the cloth;
a planar force resistance coefficient field which defines a resistance coefficient of a spring linking each mass-point in the lattice with first neighboring mass-points directly on the right, the left, above, and below;
a shift deformation resistance coefficient field which defines a resistance coefficient of a spring linking each mass-point with diagonally neighboring mass-points; and
a torsion resistance coefficient field which defines a resistance coefficient of a spring linking each mass-point with second neighboring mass-points on the right, the left, above, and below, the first neighboring mass points being between the first neighboring mass-points and the mass-points.

4. The data structure for animation of a cloth according to claim 1, wherein the physical characteristics node comprises an inverse mass field which defines an inverse mass of each of mass-points in a lattice used to obtain an acceleration used to calculate the shift position of the cloth due to the forces acting on the cloth.

5. The data structure for animation of a cloth according to claim 1, wherein the physical characteristics node comprises a time interval field which defines a time interval used to calculate the shift position of the cloth.

6. The data structure for animation of a cloth according to claim 1, further comprises a fixed edge field which defines an edge of the planar mesh of cloth that is fixed.

7. The data structure for animation of a cloth according to claim 1, further comprising a collision node used to calculate the shift position of the cloth due to the collision of the cloth with the object, and to represent the object.

8. The data structure for animation of a cloth according to claim 7, wherein the collision node comprises:
a friction coefficient field used to calculate a shift velocity of a point at which the object collides with the cloth;
a kinematics node which defines a virtual object colliding with the cloth; and
a visible shape node used to actually represent the object colliding with the cloth.

9. The data structure for animation of a cloth according to claim 8, wherein the kinematics node comprises a geometry node which is a Box node, a Sphere node, or a TruncatedCone node.

10. A 3D graphics data rendering apparatus, comprising:
an analyzer to output a scene graph obtained by discriminating nodes and analyzing fields from 3D graphics data having a data structure as described in claim 1;
a calculator to calculate physical quantities for animation of a cloth from the nodes and the fields of the scene graph and to output the scene graph comprising the calculated physical quantities; and
a converter to convert the scene graph comprising the calculated physical quantities into a 2D image and to output the 2D image.

11. The 3D graphics data rendering apparatus according to claim 10, wherein the calculator comprises:
a cloth discriminating unit to discriminate the nodes in the scene graph;
a cloth mesh creating unit to create a mesh of the cloth according to the nodes and the fields;
a physical quantity calculating unit to calculate physical quantities which represent internal and external forces acting on the cloth and a shift position of the cloth due to collision with an object; and
a cloth mesh deforming unit to deform a structure of the cloth by applying the shift position of the cloth calculated by the physical quantity calculating unit to the mesh of cloth, and to output the scene graph comprising the calculated physical quantities.

12. The 3D graphics data rendering apparatus according to claim 11, wherein the calculator further comprises:
a colliding object discriminating unit to discriminate whether the object is colliding with the cloth; and
a collision detection unit to determine whether the cloth collides with the object, and
wherein the physical quantity calculating unit calculates the shift position of the cloth due to the collision of the cloth with the object.

13. The 3D graphics data rendering apparatus according to claim 12, wherein the collision detection unit detects whether the cloth collides with a virtual object defined by a kinematics node.

14. The 3D graphics data rendering apparatus according to claim 13, wherein the collision detection unit detects a location of a collision point where the cloth collides with the virtual object defined by the kinematics node.

15. A 3D graphics data rendering method, comprising:
outputting a scene graph obtained by discriminating nodes and analyzing fields from 3D graphics data having a data structure as described in claim 1;
calculating physical quantities for animation of a cloth from the nodes and fields of the scene graph and outputting the scene graph comprising the calculated physical quantities; and
converting the scene graph comprising the calculated physical quantities into a 2D image and outputting the 2D image.

16. The 3D graphics data rendering method according to claim 15, wherein the calculating of the physical quantities comprises:
discriminating the nodes in the scene graph;
creating a mesh of the cloth according to the nodes and fields;
calculating external and internal forces acting on the cloth and a shift position of the cloth due to the external and internal forces; and
deforming a structure of the mesh of the cloth by applying the calculated shift position to the created mesh of cloth.

17. The 3D graphics data rendering method according to claim 16, wherein the calculating of the physical quantities further comprises:
discriminating whether there is an object colliding with the cloth; and
detecting whether the cloth collides with the object, and
wherein the calculating of the external and internal forces comprises calculating the shift position of the cloth due to the collision.

18. The 3D graphics data rendering method according to claim 17, wherein the detecting whether the cloth collides with the object comprises detecting whether the cloth collides with a virtual object defined by a kinematics node.

19. The 3D graphics data rendering method according to claim 18, wherein the detecting whether the cloth collides with the object further comprises detecting a location of a collision point when the cloth collides with the virtual object defined by the kinematics node.

20. A computer-readable recording medium storing a program for controlling a computer to execute operations, comprising:
outputting a scene graph obtained by discriminating nodes and analyzing fields from 3D graphics data having a data structure as described in claim 1;
calculating physical quantities for animation of a cloth from the nodes and fields of the scene graph and outputting the scene graph comprising the calculated physical quantities; and
converting the scene graph comprising the calculated physical quantities into a 2D image and outputting the 2D image.

21. The data structure for animation of a cloth according to claim 4, wherein the shift position is calculated according to Euler's method.

22. The 3D graphics data rendering method according to claim 15, wherein the outputting, calculating and converting are performed according to either a first or a second programming standard.

23. The 3D graphics data rendering method according to claim 22, wherein the first programming standard is a virtual reality modeling language, and the second programming standard is a moving picture experts group standard.
